(19) United States
(12) Patent Application Publication
(10) Pub. No.: US 2009/0121543 A1
(43) Pub. Date: May 14, 2009

(54) SYSTEM FOR DRIVING ELECTRICAL APPPLIANCES ASSOCIATED WITH A HEAT ENGINE

(76) Inventors: Claudiu Vasilescu, Paris (FR); Arnaud De Vries, Vanves (FR); Cedric Plasse, Saint Maur (FR)

Correspondence Address: BERENATO, WHITE & STAVISH, LLC, 6550 ROCK SPRING DRIVE, SUITE 240, BETHESDA, MD, 20817, US

(21) Appl. No.: 12/066,406

(22) PCT Filed: Sep. 12, 2006
(86) PCT No.: PCT/FR2006/050875

§ 371 Date: May 29, 2008

(30) Foreign Application Priority Data
Sep. 12, 2005 (FR) 0509252

(51) Int. Cl. B60L 1/00

(52) U.S. Cl. 307/10.1

(57) ABSTRACT

The invention concerns a system for driving electrical appliances and accessories via a generating function associated with a heat engine comprising a crankshaft, wherein all the consuming appliances (31-34) usually driven by a belt passing on a pulley fixed to the crankshaft are electrically powered and connected to an electric power system including one or more electric generators (11) mechanically driven by the heat engine.

The present invention concerns a system for driving various items of equipment and accessories associated with a thermal engine connected to a mechanical transmission line, in particular a system for driving the equipment of a motor vehicle.

### BACKGROUND TO THE INVENTION

It is known that the search for an increase in comfort in motor vehicles gives rise to a development in the number of items of equipment and accessories with which these motor vehicles are equipped, in particular a compressor for the air conditioning system or a pump supplying hydraulic fluid to the power steering system. These items of equipment are added to the traditional equipment such as a water pump or electrical generator.

Traditionally this equipment and certain accessories are driven in rotation by a belt passing over a pulley fixed at one end of the thermal engine crankshaft.

In addition, it is known that, in order to increase the volume available inside the vehicle cabin without increasing its external dimensions, increased compactness is sought under the engine bonnet while complying with safety standards that impose a minimum distance between the engine block and the walls of the engine compartment. This search for increased compactness is incompatible with the development of equipment which, in order to be able to be driven by a belt associated with a crankshaft, must all be mounted close to the end of the engine at which the crankshaft emerges.

It is also known, for various reasons, how to drive certain items of equipment by means of an electric motor connected to the electrical system of the vehicle. In particular, it is known how to produce electrical assisted steering in order to be able to dispose the corresponding equipment in the immediate vicinity of the steering linkage. These arrangements do however remain isolated and do not therefore substantially reduce the space occupied by the equipment associated with the engine block.

### OBJECT OF THE INVENTION

One aim of the invention is to propose a system for driving various items of equipment and accessories associated with a thermal engine, according to an arrangement for improving the compactness of the thermal engine.

### BRIEF DESCRIPTION OF THE INVENTION

With a view to achieving this aims there is proposed according to the invention a system for driving various items of equipment and accessories by a generator function, associated with a thermal engine comprising a crankshaft to which a mechanical transmission line is connected, characterised in that only the generator function is mechanically connected to the mechanical power generated by the thermal engine. Generator function means any generator or set of generators producing electricity from mechanical power, such as the thermal engine or any mechanical element participating in the movement of the vehicle such as for example the gearbox, the wheels or the rear axle. The said items of equipment or accessories consuming energy external to the thermal engine are supplied electrically and connected to an electrical system comprising one or more electrical generators driven mechanically by the thermal engine, such as for example an alternator or an alternator starter.

Thus only the generators will be located in the immediate vicinity of the thermal engine, so that the overall space requirement of the thermal engine can be considerably reduced. The electric motors that drive the said equipment or the said accessories can be disposed where required in the vehicle, and this makes it possible to free these electric motors from the thermal stresses due to the proximity of the thermal engine. In addition, the driving of the equipment and accessories by electric motors makes it possible to adapt the driving speed of the said electric motors according to optimum operating conditions for the corresponding equipment or accessories whatever the speed of rotation of the motor while mechanical driving by a belt associated with a crankshaft made the speed of rotation of the equipment dependent on the speed of the rotation of the engine, which makes it necessary to size them accordingly.

According to an advantageous version of the invention, the electrical generators are connected to a point on the transmission line downstream of the crankshaft. It is then possible to completely eliminate the pulley fixed to the end of the crankshaft so that the size of the thermal engine is reduced further.

According to a preferred embodiment of the invention, the thermal engine comprises electromagnetic actuators for the electromagnetic valves. Thus the distribution chain and the corresponding pinions are eliminated, which improves further the compactness of the engine.

According to a variant embodiment, at least one generator comprises variable-ratio drive means, and it is thus possible to choose the step-down ratio desired for driving the thermal engine and thus optimise the latter according to the power required.

### BRIEF DESCRIPTION OF THE DRAWINGS

Other characteristics and advantages of the invention will emerge from a reading of the following description of the various possibilities of implementation of the invention in relation to the accompanying figures, among which:

FIG. 1 is a schematic representation illustrating the various possible locations of electrical generators in relation to a thermal engine connected to a mechanical transmission line,

FIG. 2 is a schematic representation of an embodiment of an electrical system in relation to a system according to the invention.

### DETAILED DESCRIPTION OF THE INVENTION

The invention concerns a system for driving various item of equipment associated with a thermal engine 1 comprising a crankshaft 2 to which there is connected a mechanical transmission line designated overall as 3 comprising, in the embodiment illustrated, an inertia flywheel 4, a clutch 5, a gearbox 6 having a primary shaft 7 and a secondary shaft 8, and a rear axle 9 for mechanically driving the wheels 10 of a vehicle. Although the transmission line illustrated comprises solely mechanical components, the expression “mechanical transmission line” also covers according to the invention a transmission line comprising a hydraulic component such as a converter in the case of an automatic gearbox, or an electromagnetic clutch.

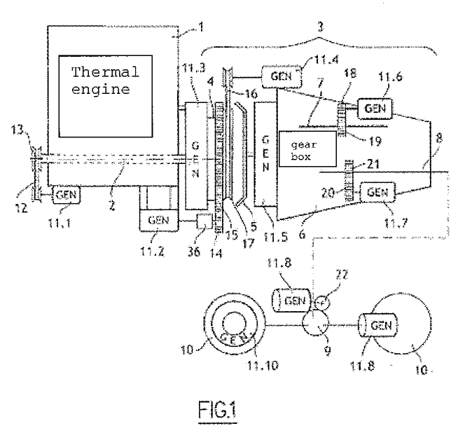

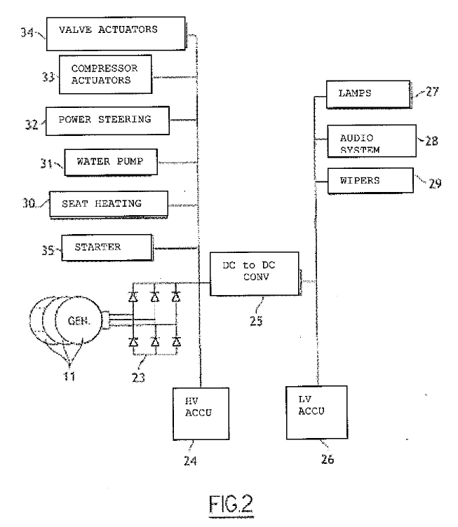

The system comprises one or more electrical generators bearing the general reference 11 in FIG. 2, and the particular references 11.1, 11.2, 11.3 . . . in FIG. 1, which illustrates the possible locations, and the mechanical driving modes. In particular, the generator 11.1 is fixed to the side of the engine block and is driven in rotation in a traditional fashion by a belt 12 passing over a pulley 13 fixed to the crankshaft 2; the generator 11.2 is fixed to the engine block and is driven by a pinion 14 associated with a variable-ratio gearbox 36 controlled by a management unit, not shown, according to the rotation speed of the engine, so as to make the generator 11.2 function in an optimum range of speeds whatever the rotation speed of the engine. The pinion 14 meshes with the toothed ring 15 fixed to the inertia flywheel 4.

The generator 11.3 is a wafer generator, whose rotor is fixed to the inertia flywheel 4 and whose stator is fixed to the engine block; the generator 11.4 is fixed to the gearbox and is driven by a belt 16 passing over a pulley 17 fixed to the inertia flywheel 4; the generator 11.5 is also a wafer generator whose rotor is fixed to the input shaft of the gearbox 6 and whose stator is fixed to the gearbox 6.

The generator 11.6 is driven by a pinion 18 meshing with a pinion 19 carried by the primary shaft 7; the generator 11.7 is driven by a pinion 20 meshing with a pinion 21 carried by the secondary shaft 8; the generator 11.8 is driven by a pinion 22 meshing with the axle 9; the generator 11.9 is mounted on a wheel shaft and the generator 11.10 is integrated in a wheel.

According to the invention in FIG. 2, the electrical generator or generators 11 are connected to an electrical system comprising a diode bridge 23 connected in a manner known per se to a high-voltage accumulator 24 and a DC to DC reversible converter 25 itself connected to a low-voltage accumulator 26. The system also comprises a management device, not shown, providing the functioning of the system according to the demand coming from the equipment connected to the system.

According to the invention, the generator or generators 11 serve not only to supply the equipment functioning traditionally with electricity such as the lamps 27, the audio system 28, the wipers 29, the starter 35 or the seat heating 30, but also other items of equipment with moving parts traditionally driven mechanically, in particular the external equipment such as the water pump 31, the power steering 32, a compressor 33 integrated in the cabin air conditioning system, and preferably electromagnetic valve actuators 34. The number of items of equipment shown is not limitative and other items of equipment can be added thereto both in the part of the system supplied at high voltage and in the part of the system supplied at low voltage.

The location of the generator or generators 11 is preferably chosen so as to improve the compactness of the engine/transmission assembly. In particular, although the invention has been illustrated in FIG. 1 with a generator 11.1 driven by pulley 13 fixed to one end of the crankshaft 2 extending so as to project with respect to the engine block, it is preferable to effect a location at a point on the transmission line downstream of the crankshaft, which makes it possible to eliminate the pulley 13. Preferably the generator or generators are connected to the inertia flywheel 4, to the primary shaft 7 of the gearbox or at an intermediate point between the inertia flywheel and the primary shaft in order to benefit from a driving of the generators as soon as the engine is running, even when the vehicle is stopped. It should be noted in this regard that the system according to the invention has not only the advantage of improving the compactness of the engine block but also makes it possible to make the equipment function at its optimum speed whatever the speed of rotation of the thermal engine, which improves the efficiency of the items of equipment and therefore reduces their size. In addition, the electrical supply to the items of equipment makes it possible to dispose these in an optimised fashion with respect to the function that they fulfil or with respect to the requirements for their cooling. The risks of deterioration normally resulting from the very high temperature under the bonnet are therefore minimised.

Naturally the invention is not limited to the embodiment illustrated and design variants can be made thereto without departing from the scope of the invention as defined by the claims.

Although the invention has been illustrated in FIG. 1 with several generators, according to circumstances only some locations will be adopted.

In particular, although the invention has been illustrated with several generators in FIG. 2, which make it possible to use small generators disposed at various points and controlled according to the operating conditions of the vehicle, it is possible to use a single generator benefiting from better overall efficiency.

Although the invention has been illustrated in relation to a thermal engine whose valves are controlled by electromagnetic actuators, the system according to the invention also applies to an engine whose valves are controlled in a traditional fashion by a camshaft, the compactness of the engine then being reduced because of the driving of the camshaft by a distribution chain.

The given examples of location of the generators are not limitative, which also applies to the means of driving these generators. In addition a variable drive ratio can be applied to each of the generators according to its location and the drive ratio may be variable discretely or continuously.

1. System for driving various items of equipment and accessories by a generator function associated with a thermal engine (1) comprising a crankshaft (2) to which a mechanical transmission line (3) is connected, characterised in that only the generator function is mechanically connected to the mechanical power generated by the thermal engine.

2. System according to claim 1, characterised in that the generator or generators (11) are connected to a point on the transmission line (3) downstream of the crankshaft (2).

3. System according to claim 2, characterised in that the transmission line (3) comprises an inertia flywheel (4) associated with a gearbox (6) having a primary shaft (7) and in that the generator or generators are connected to the inertia flywheel (4), to the primary shaft (7), or at an intermediate point between the inertia flywheel (4) and the primary shaft (7).

4. System according to claim 1, characterised in that the engine (1) comprises electromagnetic valve actuators (34) connected to the electrical system.

5. System according to claim 1, characterised in that at least one generator (11.2) comprises variable-ratio drive means (36).

6. System according to claim 1, comprising an electrical network supplied by said generator or generators equipment and accessories designed to deliver a mechanical drive among said equipment and accessories, are supplied electrically by said network.

7. System according to claim 6, in which said network comprises a high-voltage network, connected to said generator or generators and provided with said equipment and accessories, and a low-voltage network provided with said equipment and accessories, the low-voltage network and the high-voltage network being connected by a voltage converter.

8. Generator intended to be associated with a thermal engine of a motor vehicle, said engine comprising a crankshaft to which a mechanical transmission line is connected, wherein said generator is mechanically connected to the mechanical power generated by the thermal engine and wherein the generator is able to electrically supply various items of equipment and accessories delivering a mechanical drive among said equipment and accessories.

9. Generator according to claim 8, wherein said generator supplies an electrical network comprising a low-voltage network and a high-voltage network, the low-voltage network and the high-voltage network being connected by a voltage converter.

10. Electrical network comprising a generator according to claim 8, further comprising a high-voltage network connected to said generator and provided with said equipment and accessories and a low-voltage network provided with said equipment and accessories, the low-voltage network and the high-voltage network being connected by a voltage converter.
